(19) United States
(12) Patent Application Publication
(10) Pub. No.: US 2025/0121888 A1
(43) Pub. Date: Apr. 17, 2025

(54) SIDE STRUCTURE FOR VEHICLE

(71) Applicants: Hyundai Motor Company, Seoul (KR); Kia Corporation, Seoul (KR)

(72) Inventor: ChangHak Kang, Hwaseong-si (KR)

(21) Appl. No.: 18/816,512

(22) Filed: Aug. 27, 2024

(30) Foreign Application Priority Data
Oct. 17, 2023 (KR) 10-2023-0138935

(51) Int. Cl. B62D 25/02; B62D 25/04; B62D 25/06

(52) U.S. Cl. CPC B62D 25/02; B62D 25/04; B62D 25/06

(57) ABSTRACT

An embodiment side structure for a vehicle is provided. The side structure is disposed on both sides of the vehicle in a vehicle width direction and is connected to a roof structure, and the side structure includes a side outer assembly, a side inner assembly connected with the side outer assembly to define a roof side with a first closed cross-section, and a roof rail support structure connected with the side inner assembly to define a second closed cross-section connected to a roof panel of the roof structure.

### CROSS-REFERENCE TO RELATED APPLICATIONS

This application claims the benefit of Korean Patent Application No. 10-2023-0138935, filed on Oct. 17, 2023, which application is hereby incorporated herein by reference.

### TECHNICAL FIELD

The present invention relates to a vehicle body.

### BACKGROUND

Recently, the vehicle industry has been introducing a new concept of future mobility vision to realize a human-centered, dynamic future city. One of these future mobility solutions is the purpose built vehicle (PBV), which is a purpose-based mobility.

An example of a PBV is an environment-friendly mobile vehicle based on an electric vehicle (EV). These PBVs can provide various customized services to users during the travel time from the origin to the destination through unmanned or manned autonomous driving.

For this purpose, PBVs are manufactured as a one box design with a large interior space. In one example, a large-area roof panel is applied to the roof structure of the PBV to provide users with a large interior space.

Furthermore, the PBV is equipped with double door doors (e.g., twin swing doors, plug-in doors, and spinning doors) on the sides of the vehicle body to provide users with a wide and convenient boarding and alighting space.

In order to provide various services and convenience to users, the design of a vehicle body structure that strengthens the vehicle body connectivity of the PBV and minimizes deformation due to collision of the vehicle is required.

The matters described in this background section are written to improve understanding of the background of embodiments of the invention and may include matters that are not already known prior art.

### SUMMARY

The present invention relates to a vehicle body. Particular embodiments relate to a side structure of a PBV.

Embodiments of the present disclosure provide a side structure for a vehicle that can secure the connection robustness of the vehicle body and has improved performance in distributing collision load during a collision from the side direction of the vehicle body.

A side structure for a vehicle according to an exemplary embodiment is disposed on both sides of the vehicle body in a vehicle width direction and is connected to a roof structure, and the side structure may include a side outer assembly, a side inner assembly connected with the side outer assembly to form a roof side with a first closed cross-section, and a roof rail support structure connected with the side inner assembly to form a second closed cross-section connected to a roof panel of the roof structure.

The first closed cross-section and the second closed cross-section may be formed along the front-to-back direction of the vehicle body and disposed spaced apart along the vehicle width direction with a connection part connecting the side outer assembly and the side inner assembly in between.

A side structure for a vehicle according to an exemplary embodiment is disposed on both sides of the vehicle width direction, is connected to a roof structure, and is formed with a door opening part, and the side structure may include a side outer assembly, including a side outer panel and a roof side reinforcement member connected to an upper portion of the side outer panel, a side inner assembly including a side inner panel, and a roof side inner member connected to an upper portion of the side inner panel and connected to the roof side reinforcement member to form a first closed cross-section, and a roof rail support structure connected to the side inner assembly to form a second closed cross-section connected to a roof panel of the roof structure.

The roof rail support structure may include an upper support member connected to the upper portion of the side inner panel and the roof side inner member and connected to the roof panel and a lower support member connected to the upper portion of the side inner panel and connected to a lower portion of the upper support member.

The roof rail support structure may further include a roof rail side extension member connected to the upper support member and the lower support member to support a roof rail of the roof structure.

The side outer panel and the upper support member may be connected to the roof panel, and the roof panel and the upper support member connected to each other may form the second closed cross-section along the front-to-back direction of the vehicle body.

The upper support member and the lower support member connected to each other may form an opened mounting part for mounting a door operation module on the door opening part.

The roof panel, the side outer panel, and the roof side inner member may be connected through a first connection part, and the roof side reinforcement member, the roof side inner member, and the upper support member may be connected through a second connection part.

The roof side reinforcement member may include a plurality of notches formed spaced apart along the front-to-back direction of the vehicle body.

The roof side inner member may include a plurality of forming portions formed to be spaced apart along the front-to-back direction of the vehicle body and disposed in the notches.

The first connection part may include a first welding point where the roof panel, the side outer panel, and the forming portions are welded in three layers through the notches.

The second connection part may include a second welding point where the roof side reinforcement member, the roof side inner member, and the upper support member are welded in three layers between the notches.

The upper support member may include a first connection flange connected to the roof side inner member and a second connection flange connected to the roof panel.

The lower support member may include a third connection flange connected to the side inner panel and a fourth connection flange connected to the lower portion of the second connection flange.

The roof rail support structure may further include at least one first door mounting bracket connected to the lower side of the upper support member and at least one second door mounting bracket connected to the upper side of the upper support member.

The door operation module may be disposed between the upper support member and the lower support member.

The upper support member and the lower support member may be engaged with the at least one first door mounting bracket, the at least one second door mounting bracket, and the door operation module by fastening members.

According to the side structure for a vehicle according to an exemplary embodiment, the connection robustness of the vehicle body can be secured, the mounting strength of the double door type door assembly can be secured, and the collision load can be effectively distributed during a collision on the side of the vehicle.

In addition, the effects that can be obtained or predicted from exemplary embodiments will be disclosed directly or implicitly in the detailed description of the embodiments of the present invention. That is, various effects expected according to embodiments of the present invention will be disclosed in the detailed description to be described later.

### BRIEF DESCRIPTION OF THE DRAWINGS

Since these drawings are intended for reference in explaining exemplary embodiments of the present invention, the technical ideas of embodiments of the present invention should not be interpreted as limited to the accompanying drawings.

FIG. 1 is a perspective view showing an upper body of a vehicle body structure to which a side structure for a vehicle according to an exemplary embodiment is applied.

FIG. 2 is a partial exploded perspective view showing the upper body of a vehicle body structure to which the side structure for a vehicle according to an exemplary embodiment is applied.

FIG. 3 is a partial perspective view of the side structure for a vehicle according to an exemplary embodiment.

FIG. 4 is a partial exploded perspective view of the side structure for a vehicle according to an exemplary embodiment.

FIG. 5 is a cross-sectional view along line A-A in FIG. 3.

FIG. 6 is a cross-sectional view along line B-B in FIG. 3.

FIG. 7 is an exploded perspective view showing a side outer assembly applied to the side structure for a vehicle according to an exemplary embodiment.

FIG. 8 is a perspective view showing a side inner assembly applied to the side structure for a vehicle according to an exemplary embodiment.

FIG. 9 is a partial perspective view showing a roof side applied to the side structure for a vehicle according to an exemplary embodiment.

FIG. 10 and FIG. 11 are partial exploded perspective views showing a roof rail support structure applied to the side structure for a vehicle according to an exemplary embodiment.

FIG. 12 is a side view showing the side structure for a vehicle according to an exemplary embodiment.

FIG. 13 and FIG. 14 are perspective views showing an upper support member of the roof rail support structure applied to the side structure for a vehicle according to an exemplary embodiment.

FIG. 15 is a cross-sectional view showing a door assembly mounting structure of the side structure for a vehicle according to an exemplary embodiment.

The following reference identifiers may be used in connection with the drawings to describe various features of embodiments of the present invention.

| | |
|---|---|
| 1: upper body | 10: roof structure |
| 11: roof rail | 13: roof panel |
| 20: door assembly | 21: door main body |
| 23: door operation module | 31: front pillar |
| 33: first door support pillar | 35: second door support pillar |
| 37: rear pillar | 41: door opening part |
| 100: side structure | 110: side outer assembly |
| 111: side outer panel | 113: roof side reinforcement member |
| 115: notch | 116: rib |
| 120: side inner assembly | 121: side inner panel |
| 123: roof side inner member | 125: forming portion |
| 127: first closed cross-section | 129: roof side |
| 131: door opening flange | 133: first connection part |
| 135: first welding point | 160: roof rail support structure |
| 161: upper support member | 163: lower support member |
| 165: roof rail side extension | 167: first connection flange |
| member | |
| 169: second connection flange | 171: third connection flange |
| 173: fourth connection flange | 175: opened mounting part |
| 177: second connection part | 179: second welding point |
| 181: second closed cross-section | 191: first door mounting bracket |
| 193: second door mounting bracket | 195: weld nut |
| 197: fastening member | 199: engage bolt |

The drawings referenced above are not necessarily drawn to scale and should be understood as presenting a rather simplified representation of various preferred features illustrating the basic principles of embodiments of the invention. The specific design features of embodiments of the invention, including, for example, specific dimensions, orientations, locations, and shapes, will be determined in part by the particular intended application and usage environment.

### DETAILED DESCRIPTION OF ILLUSTRATIVE EMBODIMENTS

Hereinafter, with reference to the attached drawings, embodiments of the present invention will be described in detail so that those skilled in the art can easily implement the present invention. As those skilled in the art would realize, the described embodiments may be modified in various different ways, all without departing from the spirit or scope of the present invention.

The terminology used in this specification is for the purpose of describing specific exemplary disclosures and is not intended to limit the embodiments of the present invention. As used herein, singular forms are intended to also include plural forms, unless the context clearly indicates otherwise.

The terms ‘comprising’ and/or ‘including’ as used in this specification indicate the presence of specified features, integers, steps, operations, elements and/or components, but at least one other feature, integer, step, operation, element and/or component may be present. It should also be understood that this does not exclude the presence or addition of steps, operations, components, and/or groups thereof.

As used in this specification, the term ‘and/or’ includes any one or all combinations of at least one associated listed item.

In this specification, the term ‘coupled’ or ‘connected’ means that components are directly connected to each other by welding, self piercing rivet (SPR), flow drill screw (FDS), structural adhesive, etc. or indirectly connected through at least one intermediary component and indicates a physical relationship between two components.

The terms ‘vehicle,’ ‘of a vehicle,’ or other similar terms used in this specification are generally used in passenger automobiles, including passenger vehicles, sport utility vehicles (SUVs), buses, trucks, and various commercial vehicles, and also including hybrid vehicles, electric vehicles, hybrid electric vehicles, hydrogen power vehicles, and other alternative fuel vehicles (e.g., fuels derived from resources other than petroleum).

Hereinafter, exemplary embodiments of the present invention will be described in detail with reference to accompanying drawings.

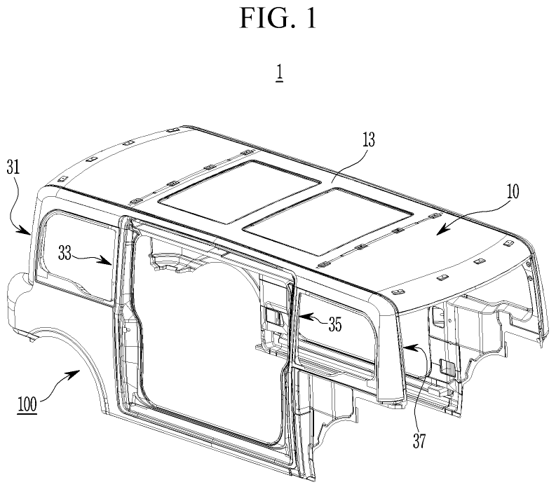

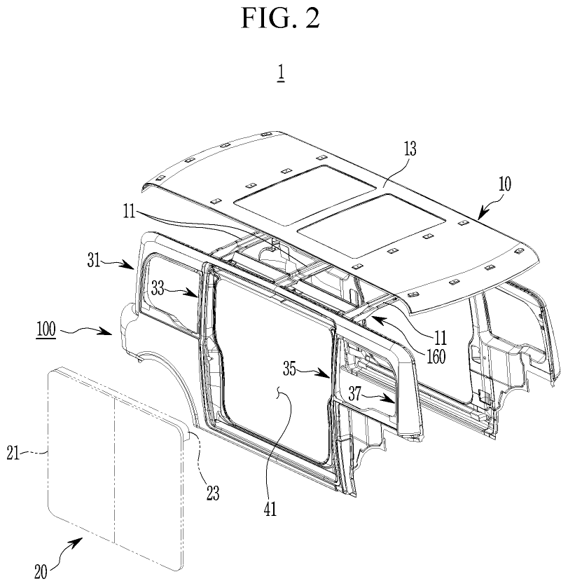

FIG. 1 is a perspective view showing an upper body of a vehicle body structure to which a side structure for a vehicle according to an exemplary embodiment is applied, and FIG. 2 is a partial exploded perspective view showing the upper body of a vehicle body structure to which the side structure for a vehicle according to an exemplary embodiment is applied.

Referring to FIG. 1 and FIG. 2, a side structure 100 for a vehicle according to an exemplary embodiment may be applied, for example, to a purpose-based mobility vehicle (purpose built vehicle: hereinafter referred to as ‘PBV’).

The PBV may be used as an electric vehicle-based life module vehicle that provides various customized services to users during the travel time from the departure point to the destination through unmanned or manned autonomous driving.

The life module vehicle described above is also commonly referred to as a ‘robo taxi,’ ‘robo shuttle,’ or ‘hailing vehicle’ by persons of ordinary skill in the art.

In one example, the PBV can be manufactured in a one box type design with a large interior space. Furthermore, the PBV can also apply facing type seats to the interior space.

This PBV vehicle body is suitable for small quantity production of various vehicle types with a small number of parts and can be manufactured in various shapes and sizes.

Furthermore, the PBV's vehicle body includes a skateboard-type underbody (not shown; commonly referred to as a ‘rolling chassis’ or ‘chassis frame’ by those skilled in the art) and an upper body 1 assembled to the underbody.

The underbody may be equipped with a battery assembly (not shown) and a drive motor (not shown). And, the upper body 1 is a body-in-white (BIW) body connected to the underbody and may include a cabin with a large indoor space.

In this specification, the ‘front-to-back direction of the vehicle body’ may be defined as the longitudinal direction of the vehicle body, the ‘vehicle width direction’ may be defined as the left-right direction of the vehicle body, and the ‘up-and-down direction’ may be defined as the height direction of the vehicle body.

Furthermore, in this specification, ‘upper end,’ ‘upper portion,’ or ‘upper surface’ of a component indicates an end, portion, or surface of a component that is relatively upper in the drawing, and ‘lower end,’ ‘lower portion,’ or ‘lower surface’ of a component indicates an end, portion, or surface of a component that is relatively lower in the drawing.

Furthermore, in this specification, an end of a component (e.g., one end or another (other) end, etc.) denotes an end of a component in any one direction, and an end portion of the component (e.g., one end portion) or other (another) end portion, etc.) denotes a portion of a component that includes that end.

The upper body 1 includes a side structure 100 provided on both sides of the vehicle in the vehicle width direction and a roof structure 10 connected to an upper portion of the side structure 100.

The roof structure 10 includes a plurality of roof rails 11 connected to the upper portion of the side structure 100 and a roof panel 13 connected to the roof rails 11.

The roof rails 11 are disposed along the vehicle width direction and may be connected to the upper portion of the side structure 100 at both ends. The roof panel 13 is connected to the upper portion of the side structure 100 and may be connected to an upper portion of the roof rails 11. In one example, this roof panel 13 may be provided as a large-area panel assembly to provide a wide interior space to the user.

Furthermore, the roof structure 10 may include various operating systems of the PBV and a roof module (not shown) of functional parts such as a roof glass (or sunroof glass).

On the other hand, the side structure 100 may include a fixed glass.

As shown in FIG. 2, the side structure 100 may include a double door type door assembly 20 to provide a wide and convenient boarding and alighting space to the user.

The double door type door assembly 20 may include, for example, a twin swing door, a plug-in door, or a spinning door. The double door type door assembly 20 includes a double door type door main body 21 and a door operation module 23 that operates the double door type door main body 21.

Since this double door type door assembly 20 is obvious to those skilled in the art, detailed descriptions of its components and functions will be omitted.

On the other hand, the side structure 100 may include a front pillar 31, a first door support pillar 33, a second door support pillar 35, and a rear pillar 37.

Here, the first door support pillar 33 and the second door support pillar 35 may form a door opening part 41 between the upper part and lower part of the side structure 100. The door assembly 20 of the double door type mentioned above may be mounted on the door opening part 41.

The side structure 100 according to an exemplary embodiment as described above includes a structure that can secure the connection robustness of the vehicle body and has improved performance in distributing a collision load during a side direction collision of the vehicle body.

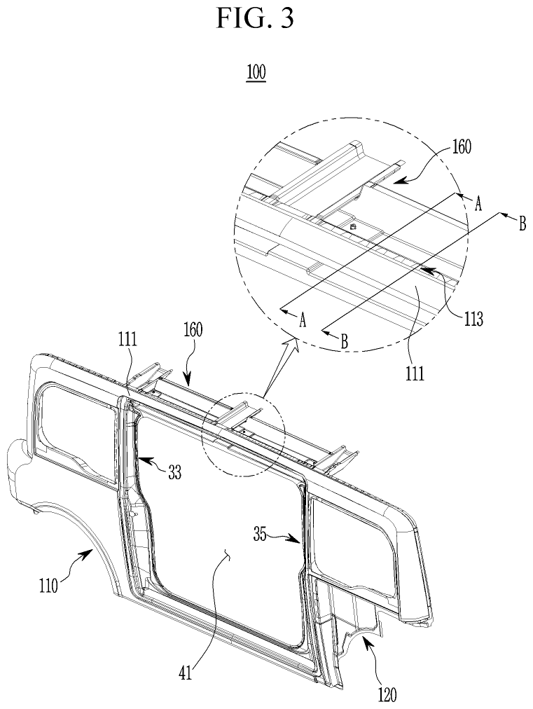

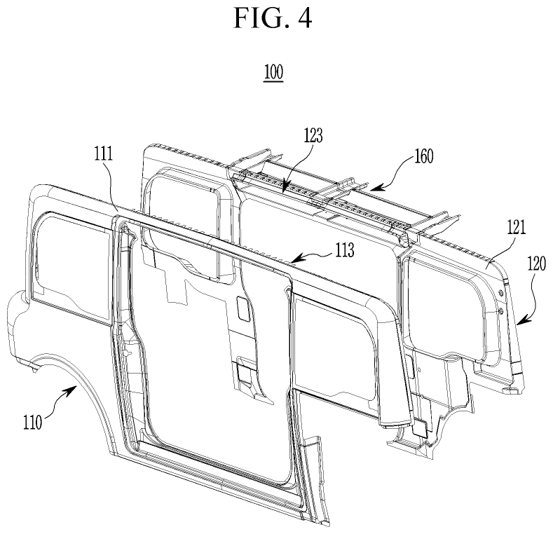

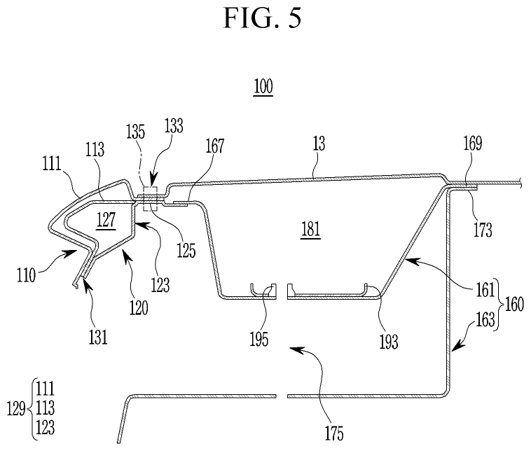

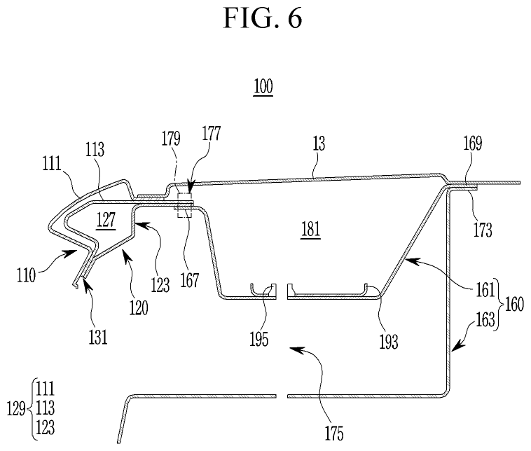

FIG. 3 is a partial perspective view of the side structure for a vehicle according to an exemplary embodiment, and FIG. 4 is a partial exploded perspective view of the side structure for a vehicle according to an exemplary embodiment. FIG. 5 is a cross-sectional view along line A-A in FIG. 3, and FIG. 6 is a cross-sectional view along line B-B in FIG. 3.

For ease of understanding, the roof panel 13 shown in FIG. 1, FIG. 2, FIG. 5, and FIG. 6 is omitted in FIG. 3 and FIG. 4.

Referring to FIG. 3 to FIG. 6, the side structure 100 according to an exemplary embodiment may include a side outer assembly 110, a side inner assembly 120, and a roof rail support structure 160.

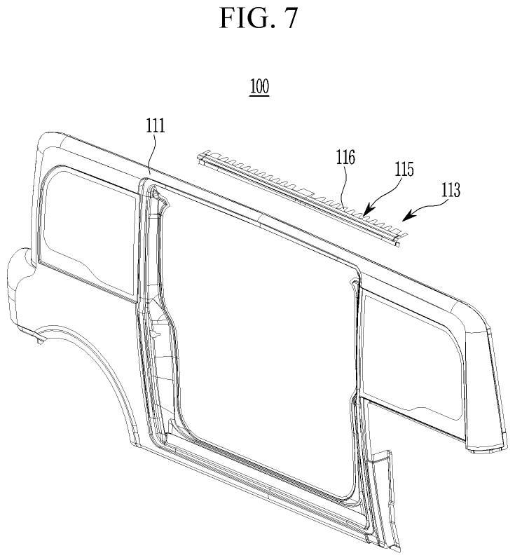

FIG. 7 is an exploded perspective view showing a side outer assembly applied to the side structure for a vehicle according to an exemplary embodiment.

Referring to FIG. 3 to FIG. 7, the side outer assembly 110 includes a side outer panel 111 and a roof side reinforcement member 113.

The side outer panel 111 may be formed into a predetermined shape by press molding. The roof side reinforcement member 113 is configured to reinforce the upper strength of the side outer panel 111.

The roof side reinforcement member 113 is connected to the upper portion of the side outer panel 111 between the first door support pillar 33 and the second door support pillar 35. The roof side reinforcement member 113 may be connected to an inner surface of the upper portion of the side outer panel 111 by welding.

As shown in FIG. 7, the roof side reinforcement member 113 includes a plurality of notches 115 formed to be spaced apart in the front-to-back direction of the vehicle body. A plurality of ribs 116 is formed between the notches 115. Accordingly, one edge portion of the roof side reinforcement member 113 may be formed of protrusions and depressions in which the notches 115 and the ribs 116 are formed continuously along the front-to-back direction of the vehicle body.

The side inner assembly 120 is coupled to the side outer assembly 110 in the vehicle width direction.

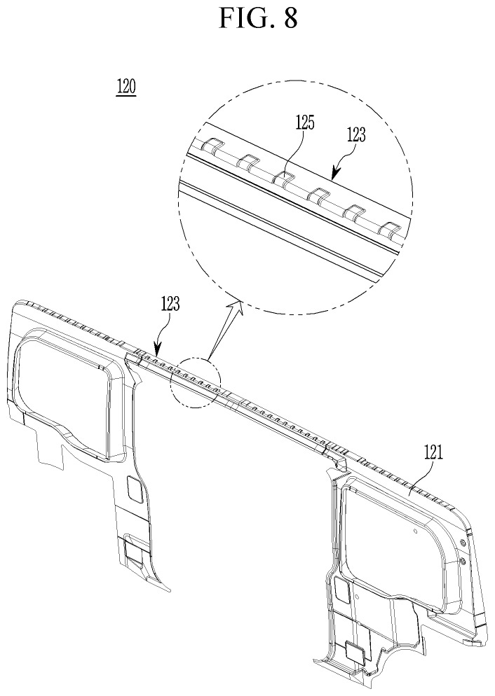

FIG. 8 is a perspective view showing a side inner assembly applied to the side structure for a vehicle according to an exemplary embodiment.

Referring to FIG. 3 to FIG. 8, the side inner assembly 120 may include a side inner panel 121 and a roof side inner member 123.

The side inner panel 121 may be formed into a predetermined shape by press molding. The side inner panel 121 is connected to the side outer panel 111 by welding in the vehicle width direction. The roof side inner member 123 is configured to reinforce the upper strength of the side inner panel 121.

The roof side inner member 123 is connected by welding to the upper portion of the side inner panel 121 between the first door support pillar 33 and the second door support pillar 35.

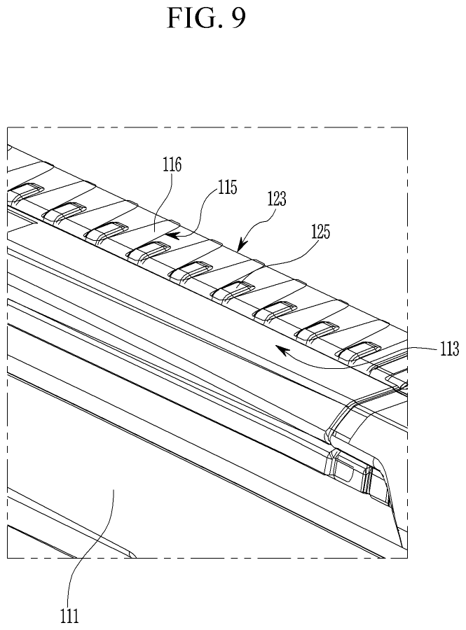

FIG. 9 is a partial perspective view showing a roof side applied to the side structure for a vehicle according to an exemplary embodiment.

As shown in FIG. 9, the roof side inner member 123 is connected to the roof side reinforcement member 113 by welding.

As shown in FIG. 8 and FIG. 9, the roof side inner member 123 includes a plurality of forming portions 125 spaced apart along the front-to-back direction of the vehicle body.

The forming portions 125 may be formed in a convex forming shape from the bottom to the top. These forming portions 125 are disposed in the notches 115 of the roof side reinforcement member 113. Furthermore, the forming portions 125 may be connected to the side outer panel 111 by welding.

As shown in FIG. 5 and FIG. 6, the roof side reinforcement member 113 and the roof side inner member 123 connected to each other may form a first closed cross-section 127 along the front-to-back direction of the vehicle body.

Additionally, the roof side inner member 123 and the side outer panel 111 may be connected by welding through the forming portions 125. The side outer panel 111, the roof side reinforcement member 113, and the roof side inner member 123 connected to each other may form a roof side 129 with the first closed cross-section 127 along the front-to-back direction of the vehicle body.

The roof side 129 may include a door opening flange 131 formed in the door opening part 41.

The side outer panel 111 is connected with the roof panel 13. Also, the side outer assembly 110 and the side inner assembly 120 may be connected through a first connection part 133.

The first connection part 133 is configured to connect the roof panel 13, the side outer panel 111, and the roof side inner member 123 along the vertical direction.

The first connection part 133 may include a first welding point 135 where the roof panel 13, the side outer panel 111, and the roof side inner member 123 are welded in three layers.

Referring to FIG. 5 and FIG. 9, the first welding point 135 may connect the roof panel 13, the side outer panel 111, and the forming portions 125 of the roof side inner member 123 through the notches 115 of the roof side reinforcement member 113.

Referring to FIG. 2 to FIG. 6, in an exemplary embodiment, the roof rail support structure 160 is configured to support the roof rails 11 of the roof structure 10. The roof rail support structure 160 is connected to the side inner assembly 120.

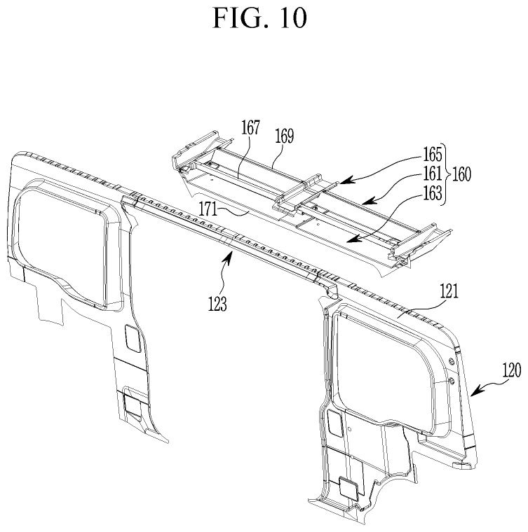

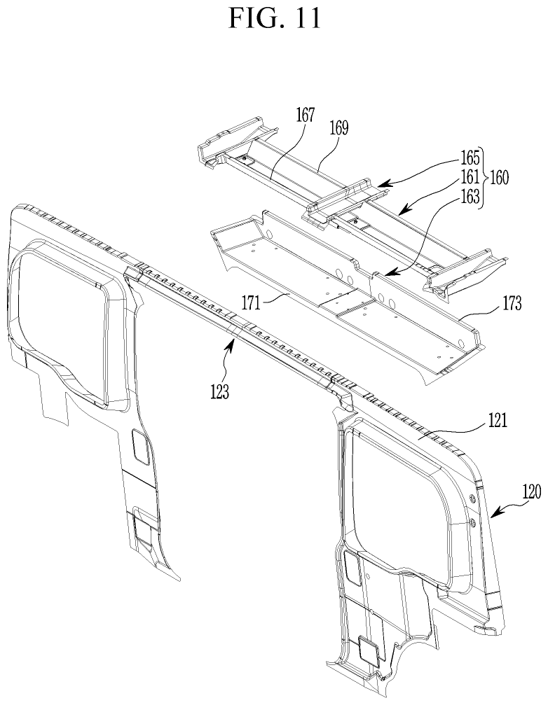

FIG. 10 and FIG. 11 are partial exploded perspective views showing a roof rail support structure applied to the side structure for a vehicle according to an exemplary embodiment.

Referring to FIG. 5, FIG. 6, FIG. 10, and FIG. 11, the roof rail support structure 160 according to an exemplary embodiment includes an upper support member 161, a lower support member 163, and a roof rail side extension member 165.

In one example, the upper support member 161 may be provided in a ‘U’ cross-section shape with the upper portion open. The upper support member 161 is connected to the upper portion of the side inner panel 121 and the roof side inner member 123. And, the upper support member 161 may be connected to the roof panel 13.

The upper support member 161 includes a first connection flange 167 connected to the roof side inner member 123 and a second connection flange 169 connected to the roof panel 13.

The lower support member 163, in one example, may be provided in an ‘L’ cross-section shape. The lower support member 163 is connected to the upper portion of the side inner panel 121 and to the lower portion of the upper support member 161.

The lower support member 163 includes a third connection flange 171 connected to the side inner panel 121, and a fourth connection flange 173 connected to the lower part of the second connection flange 169 of the upper support member 161.

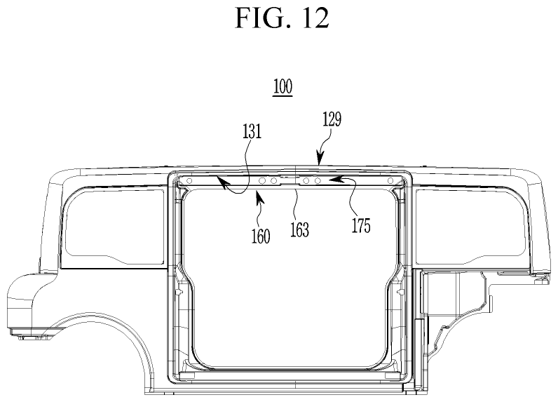

FIG. 12 is a side view showing the side structure for a vehicle according to an exemplary embodiment.

Referring to FIG. 5, FIG. 6, and FIG. 12, the upper support member 161 and the lower support member 163 of the roof rail support structure 160 are connected to each other and may form an opened mounting part 175 for mounting the door operation module 23 of the door assembly 20 as shown in FIG. 2 to the door opening part 41.

The opened mounting part 175 is formed between the upper support member 161 and the lower support member 163 and is disposed between the door opening flange 131 of the roof side 129 and the lower support member 163.

As shown in FIG. 6, the side inner assembly 120 and the roof rail support structure 160 may be connected through a second connection part 177.

The second connection part 177 is configured to connect the roof side reinforcement member 113, the roof side inner member 123, and the upper support member 161 along the vertical direction.

The second connection part 177 may include a second welding point 179 where the roof side reinforcement member 113, the roof side inner member 123, and the upper support member 161 are welded in three layers.

The second welding point 179 may connect the ribs 116 of the roof side reinforcement member 113, the roof side inner member 123, and the first connection flange 167 of the upper support member 161 between the notches 115 of the roof side reinforcement member 113 shown in FIG. 9.

On the other hand, as shown in FIG. 5 and FIG. 6, the roof panel 13 and the upper support member 161 connected to each other may form a second closed cross-section 181 along the front-to-back direction of the vehicle body.

The second closed cross-section 181 is disposed above the opened mounting part 175.

The first closed cross-section 127 and the second closed cross-section 181 are formed along the front-to-back direction of the vehicle body. And, the first closed cross-section 127 and the second closed cross-section 181 are disposed to be spaced apart along the vehicle width direction with the first connection part 133 in between.

Referring to FIG. 10 and FIG. 11, in the roof rail support structure 160 according to an exemplary embodiment, the roof rail side extension member 165 is configured to support the roof rails 11 shown in FIG. 2 along the vehicle width direction.

The roof rail side extension member 165 is connected to the upper portion of the side inner panel 121, the upper support member 161, and the lower support member 163. The roof rail side extension member 165 is disposed along the vehicle width direction and may be connected to both ends of the roof rails 11. And, the roof rail side extension member 165 and the roof rails 11 may be connected to the roof panel 13.

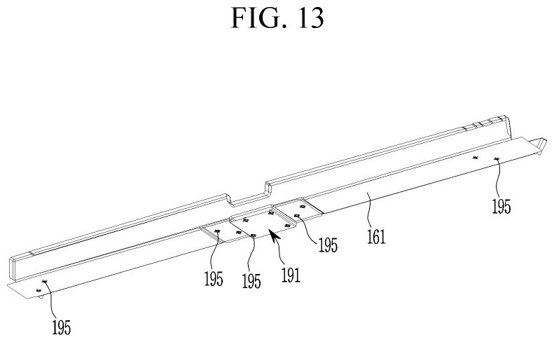

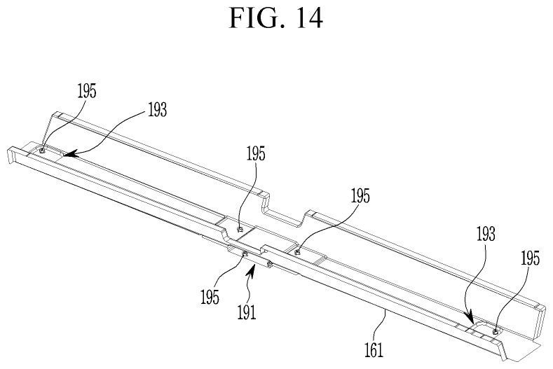

FIG. 13 and FIG. 14 are perspective views showing an upper support member of the roof rail support structure applied to the side structure for a vehicle according to an exemplary embodiment.

Referring to FIG. 10 to FIG. 14, the roof rail support structure 160 according to an exemplary embodiment further includes at least one first door mounting bracket 191 and at least one second door mounting bracket 193.

The first door mounting bracket 191 and the second door mounting bracket 193 are configured to mount the door operation module 23 of the door assembly 20 shown in FIG. 2 to the opened mounting part 175 shown in shown FIG. 5, FIG. 6, and FIG. 12.

The first door mounting bracket 191 is connected to the lower side of the upper support member 161. And, the second door mounting bracket 193 is connected to the upper side of the upper support member 161.

A plurality of weld nuts 195 are mounted on the first door mounting bracket 191 and the second door mounting bracket 193. And, on the upper side of the upper support member 161, the weld nuts 195 connected to the first door mounting bracket 191 are mounted.

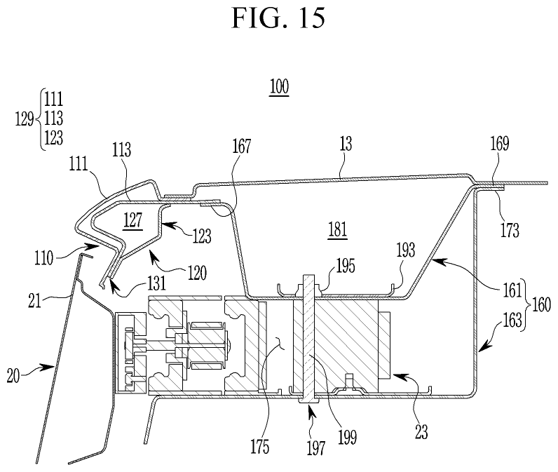

FIG. 15 is a cross-sectional view showing a door assembly mounting structure of the side structure for a vehicle according to an exemplary embodiment.

Referring to FIG. 15, the door operation module 23 of the door assembly 20 is mounted on the inside of the opened mounting part 175.

The door operation module 23 may be engaged with the upper support member 161, the lower support member 163, at least one first door mounting bracket 191, and the second door mounting bracket 193 by fastening members 197.

The fastening member 197 may include a combination of bolts and nuts. In one example, the fastening member 197 may include engage bolts 199 and the weld nuts 195.

The engage bolts 199 may be engaged with the weld nuts 195 through the lower support member 163, the door operation module 23, the first door mounting bracket 191, the upper support member 161, and the second door mounting bracket 193.

Hereinafter, the operation of the side structure 100 according to an exemplary embodiment will be described in detail referring to FIG. 1 to FIG. 15.

The side outer assembly 110 and the side inner assembly 120 are connected to form the roof side 129, and the first closed cross-section 127 is formed on the roof side 129 along the front-to-back direction of the vehicle body.

The side inner assembly 120 and the roof rail support structure 160 are connected to form the second closed cross-section 181 along the front-to-back direction of the vehicle body.

The opened mounting part 175 connected to the door opening part 41 is formed between the upper support member 161 and the lower support member 163 of the roof rail support structure 160.

The first closed cross-section 127 and the second closed cross-section 181 are disposed to be spaced apart along the vehicle width direction with the first connection part 133 in between and are connected through the first connection part 133 and the second connection part 177.

The door operation module 23 of the door assembly 20 is mounted on the inside of the opened mounting part 175 on the lower side of the second closed cross-section 181. This door operation module 23 is engaged with the upper support member 161, the lower support member 163, the first door mounting bracket 191, and the second door mounting bracket 193 by the fastening members 197.

According to the side structure 100 according to an exemplary embodiment, the cross-section coefficient of the vehicle body increases by the connect shape of the first closed cross-section 127 and the second closed cross-section 181, and the side strength of the vehicle body may be increased.

According to the side structure 100 according to an exemplary embodiment, the connection robustness of the vehicle body can be secured and the mounting strength of the double door type door assembly 20 is secured by the first closed cross-section 127 and the second closed cross-section 181 connected through the first connection part 133 and the second connection part 177.

According to the side structure 100 according to an exemplary embodiment, the first closed cross-section 127 and the second closed cross-section 181 may easily transfer the collision load to the vehicle width direction when colliding in the side direction of the vehicle.

Therefore, by forming load paths along the vehicle width direction through the first closed cross-section 127 and the second closed cross-section 181, the collision load can be effectively distributed and the deformation of the vehicle body can be minimized.

While embodiments of this invention have been described in connection with what is presently considered to be practical exemplary embodiments, it is to be understood that the invention is not limited to the disclosed embodiments. On the contrary, it is intended to cover various modifications and equivalent arrangements included within the spirit and scope of the appended claims.

What is claimed is:

1. A side structure for a vehicle, wherein the side structure is disposed on both sides of the vehicle in a vehicle width direction and is connected to a roof structure, the side structure comprising:
a side outer assembly;
a side inner assembly connected with the side outer assembly to define a roof side with a first closed cross-section; and
a roof rail support structure connected with the side inner assembly to define a second closed cross-section connected to a roof panel of the roof structure.

2. The side structure of claim 1, wherein the first closed cross-section and the second closed cross-section are disposed along a front-to-back direction of the vehicle and are disposed spaced apart along the vehicle width direction with a connection part connecting the side outer assembly and the side inner assembly disposed in between.

3. The side structure of claim 1, wherein:
the side outer assembly comprises a side outer panel and a roof side reinforcement member connected to an upper portion of the side outer panel; and
the side inner assembly comprises a side inner panel and a roof side inner member connected to an upper portion of the side inner panel and connected to the roof side reinforcement member.

4. The side structure of claim 3, wherein the roof rail support structure comprises:
an upper support member connected to the upper portion of the side inner panel and the roof side inner member and connected to the roof panel; and
a lower support member connected to the upper portion of the side inner panel and connected to a lower portion of the upper support member.

5. The side structure of claim 4, wherein the roof rail support structure further comprises a roof rail side extension member connected to the upper support member and the lower support member and supporting a roof rail of the roof structure.

6. The side structure of claim 4, wherein:
the roof panel, the side outer panel, and the roof side inner member are connected through a first connection part; and
the roof side reinforcement member, the roof side inner member, and the upper support member are connected through a second connection part.

7. The side structure of claim 3, wherein:
the roof side reinforcement member comprises a plurality of notches spaced apart along a front-to-back direction of the vehicle; and
the roof side inner member comprises a plurality of forming portions spaced apart along the front-to-back direction of the vehicle and disposed in the notches.

8. A side structure for a vehicle, wherein the side structure is disposed on both sides of the vehicle in a vehicle width direction, is connected to a roof structure, and includes a door opening part, the side structure comprising:
a side outer assembly comprising a side outer panel and a roof side reinforcement member connected to an upper portion of the side outer panel;
a side inner assembly comprising a side inner panel and a roof side inner member connected to an upper portion of the side inner panel and connected to the roof side reinforcement member to define a first closed cross-section; and
a roof rail support structure connected to the side inner assembly to define a second closed cross-section connected to a roof panel of the roof structure.

9. The side structure of claim 8, wherein the roof rail support structure comprises:
an upper support member connected to the upper portion of the side inner panel and the roof side inner member and connected to the roof panel; and
a lower support member connected to the upper portion of the side inner panel and connected to a lower portion of the upper support member.

10. The side structure of claim 9, wherein the roof rail support structure further comprises a roof rail side extension member connected to the upper support member and the lower support member and supporting a roof rail of the roof structure.

11. The side structure of claim 9, wherein:
the side outer panel and the upper support member are connected to the roof panel; and
the roof panel and the upper support member connected to each other define the second closed cross-section along a front-to-back direction of the vehicle.

12. The side structure of claim 9, wherein the upper support member and the lower support member connected to each other define an opened mounting part configured for mounting a door operation module on the door opening part.

13. The side structure of claim 9, wherein:
the roof panel, the side outer panel, and the roof side inner member are connected through a first connection part; and
the roof side reinforcement member, the roof side inner member, and the upper support member are connected through a second connection part.

14. The side structure of claim 13, wherein the roof side reinforcement member comprises a plurality of notches spaced apart along a front-to-back direction of the vehicle.

15. The side structure of claim 14, wherein the roof side inner member comprises a plurality of forming portions spaced apart along the front-to-back direction of the vehicle and disposed in the notches.

16. The side structure of claim 15, wherein the first connection part comprises a first welding point where the roof panel, the side outer panel, and the forming portions are connected by first welds in three layers through the notches.

17. The side structure of claim 16, wherein the second connection part comprises a second welding point where the roof side reinforcement member, the roof side inner member, and the upper support member are connected by second welds in three layers between the notches.

18. The side structure of claim 9, wherein:
the upper support member comprises a first connection flange connected to the roof side inner member and a second connection flange connected to the roof panel; and
the lower support member comprises a third connection flange connected to the side inner panel and a fourth connection flange connected to the lower portion of the second connection flange.

19. The side structure of claim 9, wherein the roof rail support structure further comprises:
a first door mounting bracket connected to a lower side of the upper support member; and
a second door mounting bracket connected to an upper side of the upper support member.

20. The side structure of claim 19, wherein:
the upper support member and the lower support member connected to each other define an opened mounting part configured for mounting a door operation module on the door opening part;
the door operation module is disposed between the upper support member and the lower support member; and
the upper support member and the lower support member are engaged with the first door mounting bracket, the second door mounting bracket, and the door operation module by fastening members.
